(19) United States
(12) Patent Application Publication
(10) Pub. No.: US 2026/0245263 A1
(43) Pub. Date: Aug. 20, 2026

(54) Extracting Multiple Concepts from a Single Image

(71) Applicant: Google LLC, Mountain View, CA (US)

(72) Inventors: Omri Avrahami, Jerusalem (IL); Kfir Aberman, San Mateo, CA (US); Daniel Cohen-Or, Hod HaSharon (IL); Daniel Lischinski, Jerusalem (IL)

(21) Appl. No.: 19/487,969

(22) PCT Filed: May 24, 2024
(86) PCT No.: PCT/US2024/031029

§ 371 Date: Nov. 25, 2025

Related U.S. Application Data
(60) Provisional application No. 63/504,311, filed on May 25, 2023.

(51) Int. Cl. G06T 11/00; G06T 5/60; G06T 7/11

(52) U.S. Cl. CPC G06T 11/00; G06T 5/60; G06T 7/11; G06T 2207/20081; G06T 2207/20084

(57) ABSTRACT

Provided are systems and methods that perform the following textual scene decomposition task: given a single image of a scene that may contain several concepts, the proposed techniques are able to extract a distinct text token for each concept, enabling fine-grained control over the generated scenes.

### RELATED APPLICATIONS

This application claims priority to and the benefit of U.S. Provisional Patent Application No. 63/504,311, filed May 25, 2023. U.S. Provisional Patent Application No. 63/504,311 is hereby incorporated by reference in its entirety.

### FIELD

The present disclosure relates generally to machine learning. More particularly, the present disclosure relates to textual scene decomposition and the generation of novel images from textual prompts.

### BACKGROUND

Humans possess a remarkable ability to break down complex scenes into their individual components and visualize them in different contexts. For example, when presented with a photograph of a ceramic artwork featuring a creature on a bowl, humans can effortlessly imagine the same creature in various poses and settings, or envision the bowl in a new environment. However, existing generative models face challenges when tasked with such decomposition and contextualization.

In recent years, there have been attempts to personalize large-scale text-to-image models by incorporating dedicated text embeddings or fine-tuning the model weights. These methods aim to optimize the model to generate instances of a specific concept in diverse contexts by providing multiple images of the concept. However, these approaches predominantly focus on learning a single concept from various images with variations in backgrounds and poses. They encounter difficulties when applied to different scenarios.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to extract visual concepts from imagery. The method includes obtaining, by a computing system comprising one or more computing devices, an input image and a plurality of masks, wherein the input image depicts a plurality of visual concepts, and wherein the plurality of masks respectively identify portions of the image that correspond to the visual concepts. The method includes initializing, by the computing system, a plurality of embeddings respectively for the plurality of visual concepts. The method includes, for each of one or more learning iterations: generating, by the computing system, a text prompt comprising one or more of the plurality of embeddings; processing, by the computing system, the text prompt with an image generation model to generate a synthetic image that depicts the visual concepts associated with the one or more embeddings included in the text prompt; evaluating, by the computing system, a loss function that comprises a reconstruction loss term that generates a loss value based on the input image and the synthetic image, wherein the reconstruction loss term is applied only to portions of the synthetic image that correspond to a union of one or more of the plurality of masks associated with the one or more embeddings included in the text prompt; and updating, by the computing system, the one or more embeddings included in the text prompt based on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram that illustrates the proposed concept extraction task according to example embodiments of the present disclosure.

FIG. 2 depicts a graphical diagram that illustrates an example concept extraction framework according to example embodiments of the present disclosure.

FIG. 3 depicts a graphical diagram showing effects of an example cross-attention loss according to example embodiments of the present disclosure.

FIG. 4 depicts a flow chart diagram of an example method to extract multiple concepts from an image according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to systems and methods that extract multiple visual concepts from a single image. In particular, given a single image of a scene that may contain several concepts, the proposed techniques are able to extract a distinct text token for each concept, enabling fine-grained control over the generated scenes. In particular, according to one aspect of the present disclosure, the input image can be augmented with masks that indicate the presence of the multiple target concepts. These masks can be provided by the user or generated automatically by a pre-trained segmentation model. Another aspect of the present disclosure is directed to a novel two-phase customization process that optimizes a set of dedicated textual embeddings (also referred to as “handles”), as well as the model weights, striking a delicate balance between accurately capturing the concepts and avoiding overfitting. Some example implementations employ a masked diffusion loss to enable handles to generate their assigned concepts, complemented by a novel loss on cross-attention maps to prevent entanglement. An additional aspect of the present disclosure is directed to union-sampling, a training strategy aimed to improve the ability of combining multiple concepts in generated images.

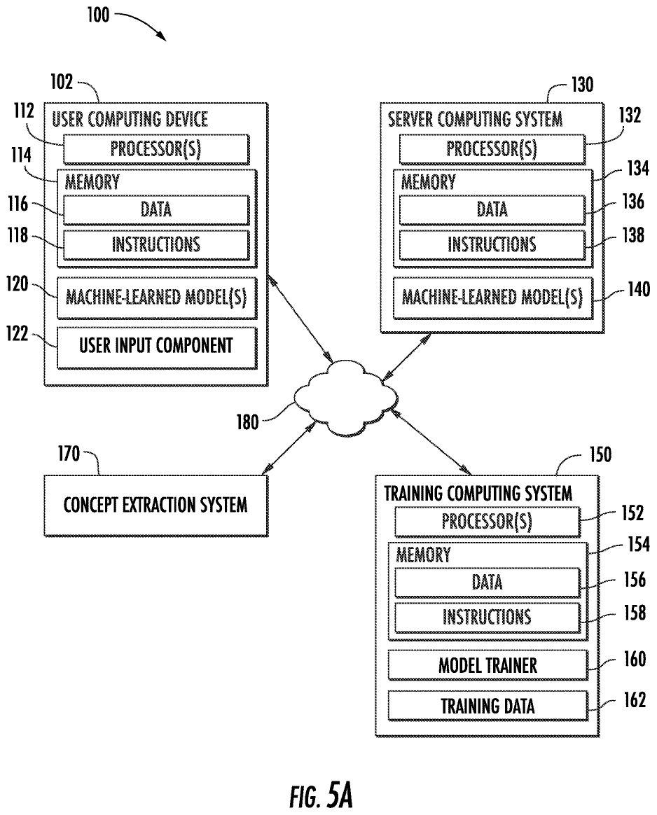

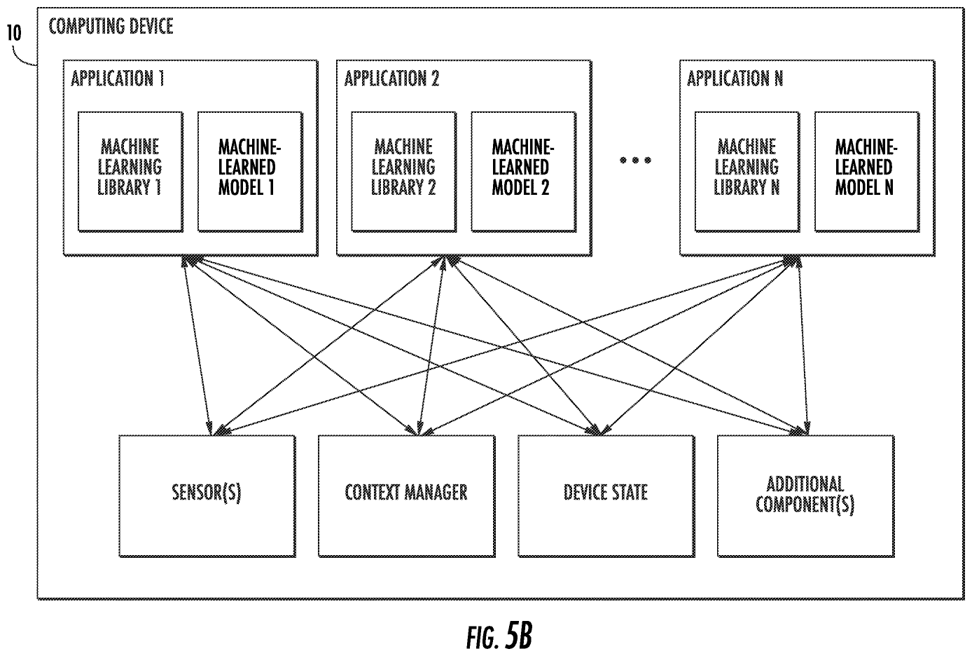

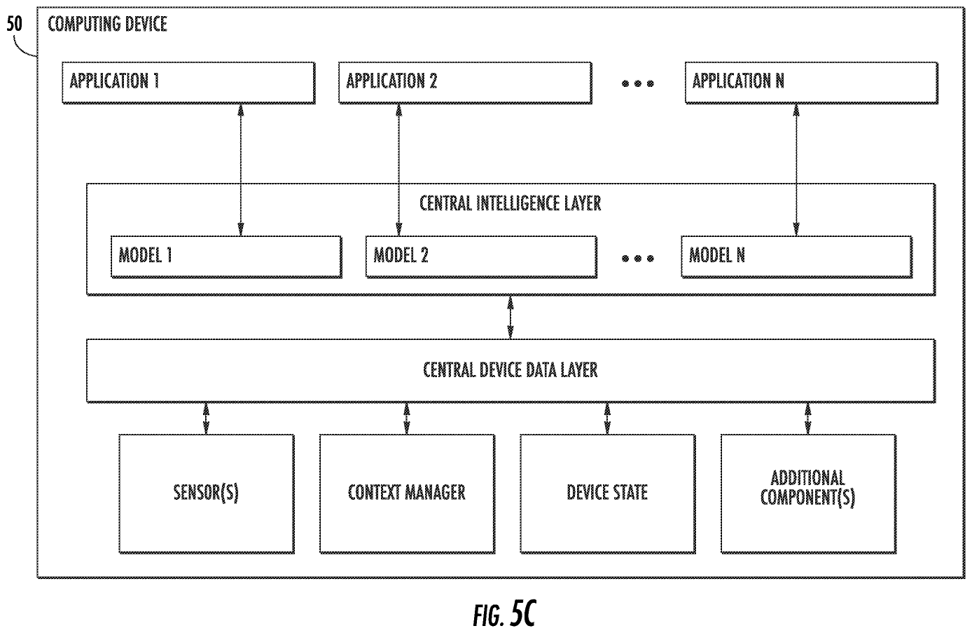

More particularly, the present disclosure introduces the new scenario of textual scene decomposition: given a single image of a scene that may contain multiple concepts of different kinds, the goal is to extract a dedicated text token for each concept. This enables generation of novel images from textual prompts, featuring individual concepts or combinations of multiple concepts, as demonstrated in FIG. 5.

In general, the personalization task can be inherently ambiguous: it is not always clear which concepts the model is intended to extract/learn. Previous works resolve this ambiguity by extracting a single concept at a time, utilizing several different images that depict the concept in different contexts. However, when switching to a single image scenario, other means are necessary to disambiguate the task. In particular, adapting two main approaches, Textual Inversion (TI) [Gal et al. 2022] and DreamBooth (DB) [Ruiz et al. 2022], to this setting reveals a reconstruction-editability tradeoff: while TI fails to accurately reconstruct the concepts in a new context, DB loses the ability to control the context due to overfitting.

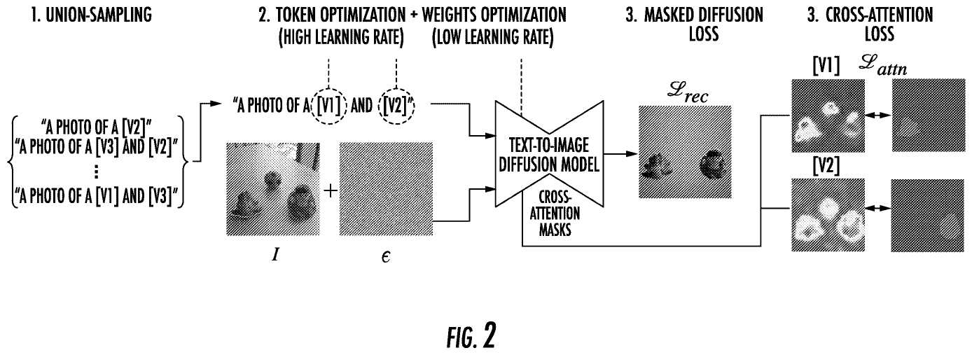

Therefore, the present disclosure proposes a novel customization pipeline that effectively balances the preservation of learned concept identity with the avoidance of overfitting. An example of the proposed pipeline is depicted in FIG. 2.

Specifically, the present disclosure proposes to augment the input image with a set of masks, indicating the concepts that are intended to be extracted. These masks may be loose masks provided by the user, or generated by an automatic segmentation method.

In some implementations, the proposed approach can be performed in two phases. In the first phase, a computing system can designate a set of dedicated text tokens (or handles), freeze the model weights, and optimize the handles to reconstruct the input image. In the second phase, the computing system can switch to fine-tuning the model weights, while continuing to optimize the handles.

The present disclosure also recognizes that in order to generate images exhibiting combinations of concepts, the customization process cannot be carried out separately for each concept. This observation leads to another example aspect of the present disclosure which can be referred to as union-sampling-a training strategy that addresses this requirement and enhances the generation of concept combinations.

One focus of the proposed approach is on disentangled concept extraction, i.e., ensuring that each handle is associated with only a single target concept. To achieve this, some example implementations of the present disclosure can employ a masked version of the standard diffusion loss, which guarantees that each custom handle can generate its designated concept; however, this loss does not penalize the model for associating a handle with multiple concepts.

Therefore, another example aspect of the present disclosure is directed to an additional loss term that penalizes such entanglement by additionally imposing a loss on the cross-attention maps, which are known to correlate with the scene layout. This additional loss can ensure that each handle attends only to the areas covered by its target concept.

Thus, the contributions of this work include: (1) the introduction of the new task of textual scene decomposition, (2) proposing a novel approach for this setting, which learns a set of disentangled concept handles, balancing between concept fidelity and scene editability, and (3) suggesting several automatic evaluation metrics and using them, along with a user study, to demonstrate the effectiveness of this method.

The systems and methods of the present disclosure provide a number of technical effects and benefits. As one example technical effect, the proposed techniques enable fine-grained control over scene generation. For example, the proposed systems can extract distinct text tokens (embeddings) corresponding to each visual concept in a given image. This feature permits fine-grained control over the generation of new images from textual prompts, allowing the user to generate images depicting individual concepts or a combination of several concepts.

As another example technical effect, the proposed techniques balance the preservation of learned concept identities with the avoidance of overfitting, making it capable of extracting multiple visual concepts from a single image, which marks a significant advancement over previous works. In particular, the proposed techniques ensure disentanglement of concept extraction, making sure each handle is associated with only a single target concept. This leads to more precise control and better representation of the image's individual elements in the generated scene.

The techniques described herein have a large number of potential use cases in various fields. As one example, the proposed techniques can be applied to perform image variation. The system's ability to generate multiple distinct text tokens corresponding to each visual concept in a given image allows for the generation of a variety of images from a single input image.

As another example, the proposed techniques can be applied to perform entangled scene decomposition. For example, the system could be used to decompose entangled scenes into individual elements. The entanglement could be due to overlapping objects, complex backgrounds, or intertwined visual elements. For instance, an image of a crowded street could be decomposed into distinct elements like pedestrians, vehicles, buildings, trees, and sky.

As another example, the proposed techniques can be applied to perform background extraction. For example, this could be employed to separate characters or objects from their backgrounds. This capability could be beneficial in post-production editing, for instance, in adding special effects or changing backgrounds without needing a green screen.

As another example, the proposed techniques can be applied to perform local editing by example. For example, with the ability to define and manipulate individual components of an image, editors could make local changes to an image based on example concepts. For instance, in an image of a room, an editor could replace a sofa with a different style or color without affecting the rest of the image, or alter the color of a dress worn by a person in a photo without changing other elements.

### Example Concept Extraction Techniques

Given a single input image I and a set of N masks

$${\{ {M}_{i} \}}_{i = 1}^{N} ,$$

indicating concepts or interest in the image, some example implementations of the present disclosure aim to extract N textual handles

$${\{ {v}_{i} \}}_{i = 1}^{N} ,$$

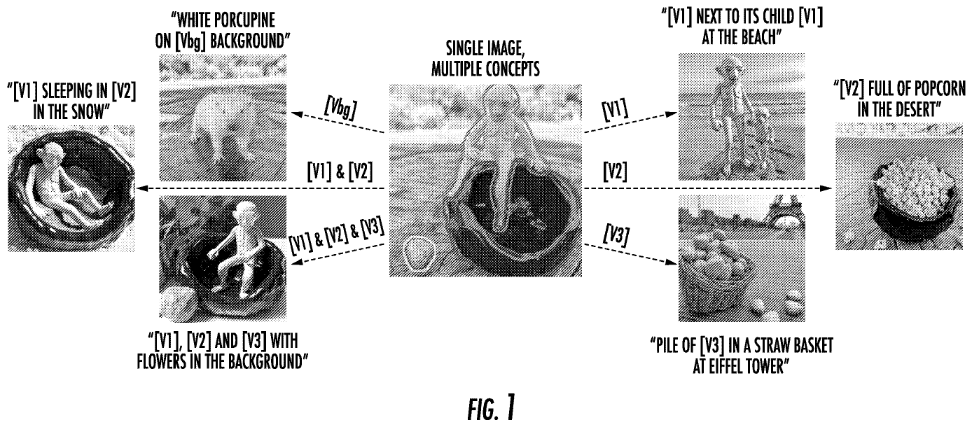

such that the i-th handle, vᵢ, represents the concept indicated by Mᵢ. The resulting handles can then be used in text prompts to guide the synthesis of new instances of each concept, or novel combinations of several concepts, as demonstrated in FIG. 1. Specifically, FIG. 1 illustrates that given a single image with multiple concepts, annotated by loose segmentation masks (middle), the proposed techniques method can learn a distinct token for each concept, and use natural language guidance to re-synthesize the individual concepts (right) or combinations of them (left) in various contexts.

In contrast, attempting to adapt TI or DB to extraction of multiple concepts from a single image (e.g., by using masks), reveals an inherent reconstruction-editability tradeoff. TI enables embedding the extracted concepts in a new context, but fails to faithfully preserve their identity, while fine-tuning the model in DB captures the identity, at the cost of losing editability, to a point of failing to comply with the guiding text prompt. Optimizing only individual tokens is not expressive enough for good reconstruction, while fine-tuning the model using a single image is extremely prone to overfitting.

Example implementations of the present disclosure therefore strive for a “middle ground” solution that would combine the best of both worlds, i.e., that would be able to capture the identity of the target concepts without relinquishing editability. Some examples of the proposed approach combine four key components, as depicted in FIG. 2. Specifically, FIG. 2 illustrates four components of an example implementation of the proposed approach: (1) in order to train the model to support different combinations of generated concepts, the illustrated example employs a union-sampling mechanism, where a random subset of the tokens is sampled each time. In addition, (2) in order to avoid overfitting, the illustrated example uses a two-phase training regime, which starts by optimizing only the newly-added tokens, with a high learning rate, and in the second phase the illustrated example also trains the model weights, using a lower learning rate. A masked diffusion loss (3) is used to reconstruct the desired concepts. Finally, (4) in order to encourage disentanglement between the learned concepts, the illustrated example uses a novel cross-attention loss.

Balancing between reconstruction and editability: Some example implementations optimize both the text embeddings and the model's weights, but do so in two different phases. In the first phase, the model is frozen, while the text embeddings corresponding to the masked concepts are optimized (e.g., using a high learning rate). Thus, an initial approximate embedding is achieved quickly without detracting from the generality of the model, which then serves as a good starting point for the next phase. In the second phase, some example implementations unfreeze the model weights and optimize them along with the text tokens (e.g., using a significantly lower learning rate). This gentle fine-tuning of the weights and the tokens enables faithful reconstruction of the extracted concepts in novel contexts, with minimal editability degradation.

Union-sampling: Further, it was observed that if the above process considers each concept separately, then the resulting customized model struggles to generate images that exhibit a combination of several concepts. Thus, some example implementations can perform union-sampling for each of the two optimization phases. Specifically, some example implementations start by designating an initial textual embedding (handle) vᵢ for each concept indicated by mask Mᵢ. In some implementations, the initial textual embeddings can be randomly assigned. In other implementations, the initial textual embeddings can be provided by the user by assigning an initial textual token or word (e.g., “dad” “the black cat”, etc.) to each concept of interest.

Next, at each training step, a subset of k≤N concepts can be randomly selected, s={i₁, . . . , iₖ}⊆[N]. A text prompt can then be constructed that includes the selected concepts. One example text prompt is “a photo of [vᵢ_{₁}] and . . . [vᵢ_{ₖ}]”. The optimization losses described below are then computed with respect to the union of the corresponding masks, Mₛ=∪Mᵢ_{ₖ}.

Masked diffusion loss: In some implementations, the handles (and the model weights, in the second phase) can be optimized using a masked version of the standard diffusion loss, i.e., by penalizing only over the pixels covered by the concept masks. One example of such as loss is as follows:

$${L}_{rec} = {𝔼}_{z , s , ϵ \sim N ( 0 , 1 ) , t} [ {‖ ϵ ⊙ {M}_{s} - {ϵ}_{θ} ( {z}_{t} , t , {p}_{s} ) ⊙ {M}_{s} ‖}_{2}^{2} ] , \qquad ( 1 )$$

where zₜ is the noisy latent at time step t, pₛ is the text prompt, Mₛ is the union of the corresponding masks, ∈ is the added noise, and, ∈_{θ} is the denoising network.

Using the masked diffusion loss in pixel space encourages the process to faithfully reconstruct the concepts, however no penalty is imposed for associating a single handle with multiple concepts. Thus, with this loss alone, the resulting handles may in some settings fail to cleanly separate between the corresponding concepts.

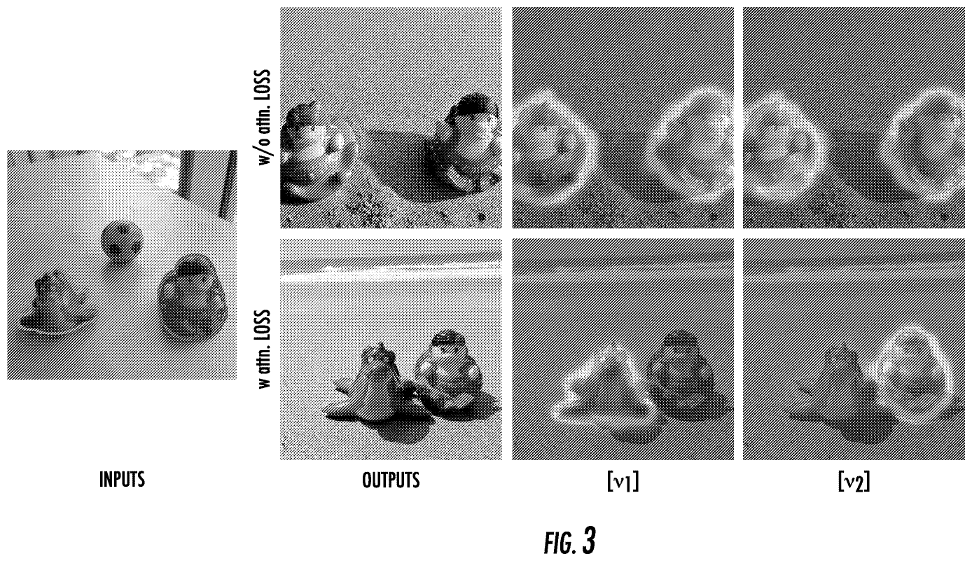

In order to understand the source of this issue, it is helpful to examine the cross-attention maps between the learned handles and the generated images, as visualized in FIG. 3 (top row). It may be seen that both handles [v₁] and [v₂] attend to the union of the areas containing the two concepts in the generated image, instead of each handle attending to just one concept, as would have been preferred.

Cross-Attention loss: Some example implementations therefore include and use another loss term that encourages the model to not only reconstruct the pixels of the learned concepts, but also ensures that each handle attends only to the image region occupied by the corresponding concept.

Specifically, as illustrated in FIG. 3 (right), a proposed loss term utilizes the cross-attention maps for the newly-added tokens and penalize their MSE deviation from the input masks. Formally, one example of such a loss term is as follows. This loss term can be used in one or both of the training phases:

$${L}_{attn} = {𝔼}_{z , k , t} [ {‖ {CA}_{θ} ( {v}_{i} , {z}_{t} ) - {M}_{{i}_{k}} ‖}_{2}^{2} ] , \qquad ( 2 )$$

where CA_{θ}(vᵢ, zₜ) is the cross-attention map between the token vᵢ and the noisy latent zₜ.

The cross attention maps can be calculated over several layers of the denoising model (e.g., which may be a UNet). Thus, in some implementations, the total loss used is:

$${L}_{total} = {L}_{rec} + {λ}_{attn} {L}_{attn} , \qquad ( 3 )$$

where λₐₜₜₙ is a tuning hyper parameter. In one example, λₐₜₜₙ=0.01.

As can be seen in FIG. 3 (bottom row), the addition of Lₐₜₜₙ to the loss succeeds in ensuring that [v₁] and [v₂] attend to two distinct regions, corresponding to the appropriate spatial locations in the generated image.

### Example Methods

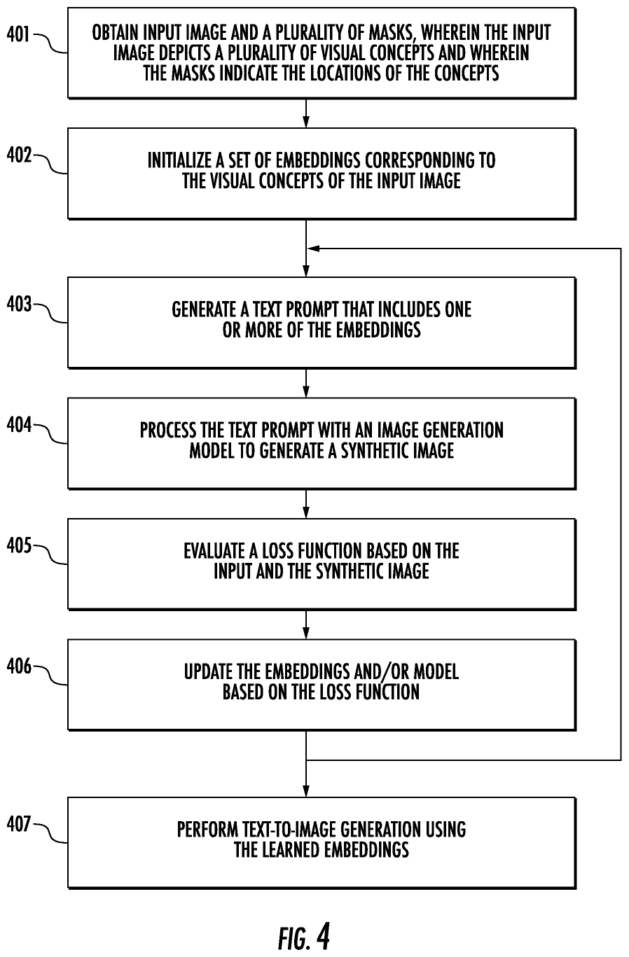

FIG. 4 depicts a flow chart diagram of an example method for extracting visual concepts from an image according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

In step 401, a computing system obtains an input image and a plurality of masks. For example, the input image can be a high-resolution RGB image with complex scenes, objects, and textures. The masks, which can be binary images corresponding to the different visual concepts in the image, can be manually created by users using tools like Adobe Photoshop, or automatically generated using a deep learning-based segmentation model, such as U-Net or Mask R-CNN.

Step 402 involves initializing a set of embeddings corresponding to the visual concepts identified in the image. Each embedding, for instance, could be a vector in a high-dimensional space, initialized randomly or using pre-trained models like Word2Vec or GloVe. The dimensionality and initialization strategy of the embeddings can be adjusted based on the complexity of the visual concepts.

The system then proceeds to a loop that runs for one or more learning iterations. For example, the number of iterations could be a hyperparameter tuned based on the computational resources and the complexity of the task. During each iteration, the system carries out steps 403-406.

In step 403, the system generates a text prompt incorporating one or more of the embeddings. This could include generating the text prompt with two or more of the embeddings or even all of the embeddings.

Step 404 involves processing the text prompt with an image generation model, resulting in the creation of a synthetic image. This image depicts the visual concepts associated with the embeddings included in the text prompt. For instance, the image generation model could be a generative adversarial network (GAN), a variational autoencoder (VAE), or a more complex latent diffusion model. The latter uses a series of noise-adding and denoising steps to generate the synthetic image. Thus, in some implementations, the image generation model can be a latent diffusion model that creates the synthetic image from a noised latent image.

Next, in step 405, the system evaluates a loss function. The function includes a reconstruction loss term that generates a loss value based on a comparison of the input image and the synthetic image. As an example, in cases where a latent diffusion model is used, the reconstruction loss can be a latent diffusion loss that measures the difference between a predicted set of noise linked to the synthetic image and a set of noise intentionally added to the input image during the generation of the noised latent image. This contrast provides a mechanism to gauge the quality of the synthetic image generation.

In some implementations, this term is only applied to portions of the synthetic image that match a union of the masks associated with the embeddings in the text prompt. These portions correspond to areas identified by a union of masks, which identify regions of interest in the image. The model, therefore, focuses on reconstructing the areas of the image that contain important visual concepts, rather than the entire image, making the process more efficient and focused.

In certain implementations, the loss function may also contain a cross-attention loss term. This term generates a loss value for each embedding in the text prompt based on a comparison of the associated mask and a cross-attention map created for each embedding.

Step 406 involves updating the embeddings in the text prompt and/or the image generation based on the evaluated loss function. In particular, the learning iterations can be divided into a first stage and a second subsequent stage. During the first stage, the system updates the embeddings at step 406 while keeping the image generation model fixed, e.g., applying a high learning rate for updating. During the second stage, both the embeddings and the image generation model are updated at step 406 based on the loss function, e.g., but a lower learning rate is applied. The update could be performed using gradient-based optimization algorithms such as stochastic gradient descent (SGD), RMSprop, or Adam.

The loop of steps 403-406 repeats for the desired number of learning iterations. Once completed, the system has effectively extracted visual concepts from the input image and represented them as embeddings that can be used for subsequent image generation or manipulation tasks.

Step 407 involves performing text-to-image generation utilizing the embeddings extracted from the previous steps. There are a number of potential text-to-image generation applications that can be performed at 407.

As one example, given a single image with multiple concepts, one can generate image variations by prompting the model with a specific text prompt such as “a photo of [concept 1] and [concept 2]”. This prompt drives the generation of a new image that rearranges the objects in the scene or alters the background while preserving the key visual concepts.

As another example, if an input image depicts a dog wearing a shirt, our method can learn and separate the dog and the shirt concepts, enabling the generation of new images such as a dog without the shirt or a cat wearing that specific shirt. This capacity to decompose composite objects into distinct concepts provides a unique advantage in handling complex visual data.

Another example application is background extraction. In many cases, the background of an image can be considered as one of the visual concepts. The background mask can be automatically defined as the complement of the union of all the input masks. Therefore, it is possible to extract a specific background (for example, a beach) and generate new objects within it, maintaining a coherent representation such as correct water reflections for newly generated objects.

As another example, local image editing can be accomplished once the concepts have been extracted. An off-the-shelf text-driven local image editing method can be used to edit other images. For example, a technique such as Blended Latent Diffusion could be used to embed the extracted concepts inside the indicated regions of another image while preserving the rest of it. This application offers a powerful way to manipulate images based on textual prompts and region-specific indications, facilitating a fine-grained textual control over each of the edited regions.

### Example Devices and Systems

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Other example machine-learned models include diffusion models such as denoising models. Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of concepts).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a concept extraction and image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Other example machine-learned models include diffusion models such as denoising models. Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, images. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The system 100 can also include a concept extraction system 170 that is configured to perform any of the techniques or methods described herein. The concept extraction system 170 can optionally be integrated into the user computing device, server computing system, or the training computing system, or can operate as a standalone component. It can include or be implemented using a processor and a memory.

The concept extraction system 170 is configured to identify and extract visual concepts from input images and represent them in the form of embeddings, which can be utilized for various image generation or manipulation tasks. As one example, the concept extraction system 170 can perform the method illustrated in FIG. 4.

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to extract visual concepts from imagery, the method comprising:
obtaining, by a computing system comprising one or more computing devices, an input image and a plurality of masks, wherein the input image depicts a plurality of visual concepts, and wherein the plurality of masks respectively identify portions of the image that correspond to the visual concepts;
initializing, by the computing system, a plurality of embeddings respectively for the plurality of visual concepts; and
for each of one or more learning iterations:
generating, by the computing system, a text prompt comprising one or more of the plurality of embeddings;
processing, by the computing system, the text prompt with an image generation model to generate a synthetic image that depicts the visual concepts associated with the one or more embeddings included in the text prompt;
evaluating, by the computing system, a loss function that comprises a reconstruction loss term that generates a loss value based on the input image and the synthetic image, wherein the reconstruction loss term is applied only to portions of the synthetic image that correspond to a union of one or more of the plurality of masks associated with the one or more embeddings included in the text prompt; and
updating, by the computing system, the one or more embeddings included in the text prompt based on the loss function.

2. The computer-implemented method of claim 1, wherein the loss function further comprises a cross-attention loss term, wherein the cross-attention loss term generates a loss value for each of the one or more embeddings included in the text prompt based on a comparison of the mask associated with each of the one or more embeddings with a cross-attention map generated for each of the one or more embeddings.

3. The computer-implemented method of claim 1, wherein the image generation model comprises a latent diffusion model that generates the synthetic image from a noised latent image, and wherein the reconstruction loss measures a difference between a predicted set of noise associated with the synthetic image and a set of added noise that was added to the input image to generate the noised latent image.

4. The computer-implemented method of claim 1, wherein:
the one or more learning iterations comprise a plurality of learning iterations;
the plurality of learning iterations are performed for a first stage and a second, subsequent stage;
during the first stage, updating, by the computing system, the one or more embeddings included in the text prompt based on the loss function comprises updating, by the computing system, the one or more embeddings while holding the image generation model fixed; and
during the first stage, updating, by the computing system, the one or more embeddings included in the text prompt based on the loss function comprises updating, by the computing system, both the one or more embeddings and the image generation model based on the loss function.

5. The computer-implemented method of claim 4, wherein:
updating, by the computing system, the one or more embeddings during the first stage comprises applying a first learning rate;
updating, by the computing system, both the one or more embeddings and the image generation model during the second stage comprises applying a second learning rate; and
the first learning rate is greater than the second learning rate.

6. The computer-implemented method of claim 1, wherein generating, by the computing system, the text prompt comprising the one or more of the plurality of embeddings comprises generating, by the computing system, the text prompt comprising two or more of the plurality of embeddings.

7. The computer-implemented method of claim 1, wherein generating, by the computing system, the text prompt comprising the one or more of the plurality of embeddings comprises generating, by the computing system, the text prompt comprising all of the plurality of embeddings.

8. The computer-implemented method of claim 1, wherein obtaining, by the computing system, the plurality of maps comprises receiving, by the computing system, the plurality of maps as an input from a user.

9. The computer-implemented method of claim 1, wherein obtaining, by the computing system, the plurality of maps comprises generating, by the computing system, the plurality of maps by processing the input image with a machine-learned segmentation model.

10. A computer-implemented method to perform text-to-image generation, the method comprising:
receiving, by a computing system, a text prompt comprising one or more embeddings, wherein the one or more embeddings were learned according to the method of any preceding claim;
processing, by the computing system, the text prompt with an image generation model to generate a synthetic image; and
providing, by the computing system, the synthetic image as an output.

11. The computer-implemented method of claim 10, wherein the text prompt comprises an image variation prompt.

12. The computer-implemented method of claim 10, wherein the text prompt comprises some but not all of the plurality of embeddings.

13. The computer-implemented method of claim 10, wherein at least one of the embeddings in the text prompt corresponds to an image background.

14. The computer-implemented method of claim 10, wherein the method further comprises receiving data indicating a specified region of an image to edit; and wherein the synthetic image depicts, in the specified region, one or more visual concepts associated with at least one of the one or more embeddings.

15. (canceled)

16. (canceled)
